(19) United States
(12) Patent Application Publication
(10) Pub. No.: US 2009/0321344 A1
(43) Pub. Date: Dec. 31, 2009

(54) HEADER FOR FILTERING MEMBRANE MODULE AND FILTERING MEMBRANE MODULE USING THE SAME

(75) Inventors: Kwang-Jin LEE, Yongin-si (KR); Moo-Seok LEE, Seoul (KR); Yong-Cheol SHIN, Seoul (KR)

Correspondence Address: SUGHRUE MION, PLLC, 2100 PENNSYLVANIA AVENUE, N.W., SUITE 800, WASHINGTON, DC, 20037, US

(73) Assignee: KOLON INDUSTRIES, INC., Kwacheon-si (KR)

(21) Appl. No.: 12/486,112

(22) Filed: Jun. 17, 2009

(30) Foreign Application Priority Data
Jun. 27, 2008 (KR) 10-2008-0061408

(51) Int. Cl. B01D 63/00; B01D 35/30

(52) U.S. Cl. 210/321.72; 210/455

(57) ABSTRACT

A header for filtering membrane module and a filtering membrane module using the same is disclosed, which is capable of maximizing efficiency in power consumption by securing a constant flow of permeate through the use of a relatively-low negative pressure, the header for filtering membrane module comprising a body with a permeate collecting space therein; and a conduit at one end of the body, the conduit being in fluid communication with the permeate collecting space, wherein at least a portion of the permeate collecting space has an inclined shape.

This application claims the benefit of Korean Patent Application No. 10-2008-0061408 filed on Jun. 27, 2008, which is hereby incorporated by reference for all purposes as if fully set forth herein.

### BACKGROUND OF THE INVENTION

1. Field of the Invention

The present invention relates to a header for filtering membrane module and a filtering membrane module using the same, and more particularly to a header for filtering membrane module and a filtering membrane module using the same, which is capable of achieving maximum usefulness for all hollow fiber membranes potted into a header without regard to its potting position, and maximizing efficiency in power consumption by securing a constant flow of permeate through the use of a relatively-low negative pressure.

2. Discussion of the Related Art

A separation method using a membrane has lots of advantages compared to the method based on a phase inversion or heating. Among the advantages is high reliability of water treatment since the water purity required may be easily and stably satisfied by adjusting the size of the pores of a membrane. Furthermore, since the separation method using a membrane does not require a heating process, a membrane can be used with microorganism which is useful for separation process but may be adversely affected by heat.

The separation method using a membrane has been widely used in the field of microfiltration and ultrafiltration for obtaining axenic water, drinking water, super pure water, and so on. Recently, however, application of the separation method using a membrane is being expanded to include wastewater treatment, solid-liquid separation in a septic tank, removal of suspended solid (SS) from industrial wastewater, filtration of river, filtration of industrial water, and filtration of swimming pool water.

Among such the filtering membrane modules is a submerged filtering membrane module which is submerged into a tank of feed water to be treated. Negative pressure is applied to the internal parts of the filtering membranes such that only fluid passes through the walls of the filtering membranes and solids and sludge are rejected and accumulate in the tank. A submerged filtering membrane module is advantageous in that the manufacturing cost is relatively low and that the installation and maintenance cost may be reduced since a facility for circulating fluid is not required.

A typical example of the submerged filtering membrane module is a submerged hollow fiber membrane module using bundles of hollow fiber membranes.

FIG. 1 is a perspective view of a related art submerged hollow fiber membrane module.

As shown in FIG. 1, the related art submerged hollow fiber membrane module includes a plurality of hollow fiber membranes 20, wherein both ends of each hollow fiber membrane 20 are open. The plurality of hollow fiber membranes 20 are provided in a bundle. Also, one end of each hollow fiber membrane 20 is potted into a potting layer 30 made of polyurethane in a header body 10.

A permeate collecting space 11 is provided inside the header body 10. According as the open end of each hollow fiber membrane 20 is fluid communication with the permeate collecting space 11, permeate flows into the permeate collecting space 11 through the hollow fiber membrane 20.

A conduit 12 is provided at one end of the header body 10 while being in fluid communication with the permeate collecting space 11. In case of the submerged hollow fiber membrane module, a liquid substrate can be treated by applying a negative pressure to the hollow fiber membrane 20 through the conduit 12.

As shown in FIG. 1, in case of the submerged hollow fiber membrane module, the conduit 11 has the same cross-section size along a longitudinal direction of the header body 10. That is, the cross-section size of the permeate collecting space 11 is constantly maintained along the longitudinal direction of the header body 10 from one end of the header body 10 to the other end thereof, wherein the cross section of the permeate collecting space 11 is perpendicular to the longitudinal direction of the header body 10.

Accordingly, it is inevitable that a pressure drop gradually gets worse from one end of the permeate collecting space 11, which is adjacent to the conduit 12, to the other end of the permeate collecting space 11. Thus, it is difficult to provide an appropriate amount of negative pressure to the hollow fiber membrane 20 being in fluid communication with the other end of the permeate collecting space 11, and it is impossible to use all the hollow fiber membranes 20 without regard to the potting position.

If increasing an amount of negative pressure applied through the conduit 12 in consideration for the pressure drop at any level, the appropriate amount of negative pressure may be provided to the hollow fiber membrane 20 being in fluid communication with the other end of the permeate collecting space 11. However, in order to sufficiently increase the amount of negative pressure provided, power consumption is inevitably increased.

### SUMMARY OF THE INVENTION

Accordingly, the present invention is directed to a header for filtering membrane module and a filtering membrane module using the same that substantially obviates one or more of the problems due to limitations and disadvantages of the related art.

An aspect of the present invention is to provide a header for filtering membrane module and a filtering membrane module using the same, which is capable of achieving maximum usefulness for all hollow fiber membranes potted into a header without regard to its potting position, and maximizing efficiency in power consumption by securing a constant flow of permeate through the use of a relatively-low negative pressure.

Additional features and aspects of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, there is provided a header for filtering membrane module comprising a body with a permeate collecting space therein; and a conduit at one end of the body, the conduit being in fluid communication with the permeate collecting space, wherein at least a portion of the permeate collecting space has an inclined shape.

To minimize a pressure drop in negative pressure provided from the conduit of the permeate collecting space, a cross-section size of the permeate collecting space is gradually decreased from the one end of the body to the other end of the body, and a cross section of the permeate collecting space is perpendicular to a longitudinal direction of the body. Also, the cross section of the permeate collecting space has a semicircle shape.

To minimize a material consumed for manufacturing the header body, at least a portion of the body has an inclined shape. Also, a cross-section size of the body is gradually decreased from the one end to the other end, and a cross section of the body is perpendicular to a longitudinal direction of the body. Also, the cross section of the body has a U-shape.

In another aspect of the present invention, there is provided a filtering membrane module comprising a filtering membrane with an open end; a header body with a permeate collecting space therein; a potting layer for potting the filtering membrane into the header body in such a way that the open end of the filtering membrane is in fluid communication with the permeate collecting space; and a conduit at one end of the header body, the conduit being in fluid communication with the permeate collecting space, wherein at least a portion of the permeate collecting space has an inclined shape.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view illustrating a related art submerged hollow fiber membrane module; and

FIGS. 2 to 5 are perspective views illustrating various submerged hollow fiber membrane modules according to embodiments of the present invention.

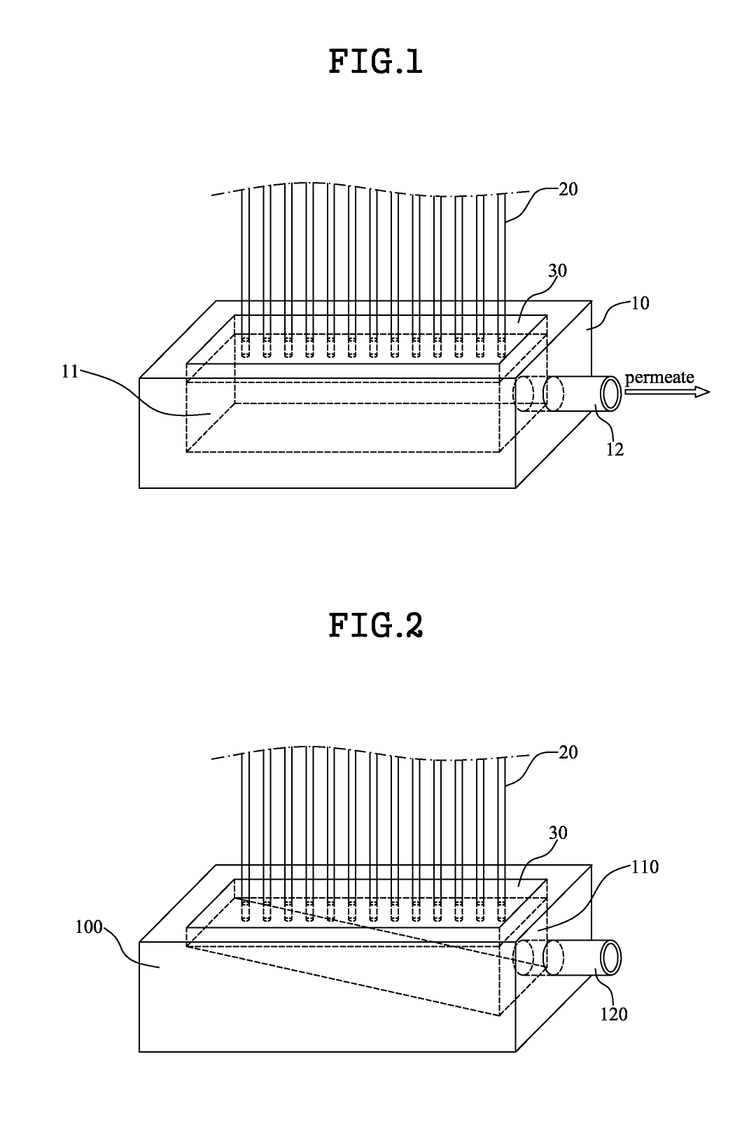

### DETAILED DESCRIPTION OF THE ILLUSTRATED EMBODIMENTS

Reference will now be made in detail to an embodiment of the present invention, example of which is illustrated in the accompanying drawings.

Hereinafter, a header for filtering membrane module according to the present invention and a filtering membrane module using the same will be described with the accompanying drawings.

The present invention can be applicable to any filtering membrane module which is capable of filtering solids from liquid substrate to be treated by a method of applying a negative pressure thereto while the filtering membrane module is submerged into the liquid substrate to be treated, without regard to the type of filtering membrane module, for example, flat sheet membrane or hollow fiber membrane.

Also, the present invention can be identically applied to both a through-both-ends water collection type and a through-one-end water collection type, wherein the through-both-ends water collection type uses two headers so as to collect permeate from both ends of the hollow fiber membrane, and the through-one-end water collection type use one header so as to collect permeate from one end of the hollow fiber membrane.

FIGS. 2 to 5 are perspective views illustrating various submerged hollow fiber membrane modules according to embodiments of the present invention.

The submerged hollow fiber membrane module shown in FIG. 2 includes a plurality of hollow fiber membranes 20, wherein both ends of each hollow fiber membrane 20 are open. The plurality of hollow fiber membranes 20 are provided in a bundle. Also, one end of each hollow fiber membrane 20 is potted into a potting layer 30 made of poly urethane in a header body 100.

The hollow fiber membrane 20 may have a composite hollow fiber membrane made by coating a tubular braid with a polymer resinous thin film, or may have a single-layered membrane made of polymer resin. In this case, the polymer resin for forming the hollow fiber membrane may be polysulfone(PS) resin, polyethersulfone(PES) resin, sulfonated polysulfone(SPSF) resin, polyvinylidene difluoride(PVDF) resin, polyacrylonitrile(PAN) resin, polyimide resin, polyamideimide(PAI) resin, or polyesterimide(PEI) resin. It is apparent that the kind and structure for the membrane and the resin used for the membrane can be appropriately selected by those skilled in the art.

A permeate collecting space 110 is provided inside the header body 100. According as the open end of each hollow fiber membrane 20 is fluid communication with the permeate collecting space 110, permeate flows into the permeate collecting space 110 through the hollow fiber membrane 20.

A conduit 120 is provided at one end of the header body 100 while being in fluid communication with the permeate collecting space 110. The negative pressure is applied to the hollow fiber membrane 20 through the conduit 120 so that only permeate passes through the hollow fiber membrane 20 by filtering out solids from the liquid substrate.

As shown in FIG. 2, in case of the submerged hollow fiber membrane module according to one embodiment of the present invention, at least a portion of the permeate collecting space 110 provided inside the header body 100 is formed in such an inclined shape. In more detail, the cross section of the permeate collecting space 110 is perpendicular to a longitudinal direction of the header body 100, and the cross-section size of the permeate collecting space 110 is changed along the longitudinal direction of the header body 100, that is, the cross-section size of the permeate collecting space 110 is gradually decreased from one end of the header body 100 to the other end of the header body 100.

This structure of the permeate collecting space 110 enables a minimization of pressure drop for the negative pressure applied through the conduit 120 even at a position being distant from the conduit 120 inside the permeate collecting space 110. Eventually, all the hollow fiber membranes 20 being in fluid communication with the permeate collecting space 110 can be used efficiently without regard to the potting position of each hollow fiber membrane 20. Also, it is possible to secure the constant flow of permeate through the use of the relatively-low negative pressure, thereby resulting in the maximized efficiency in power consumption.

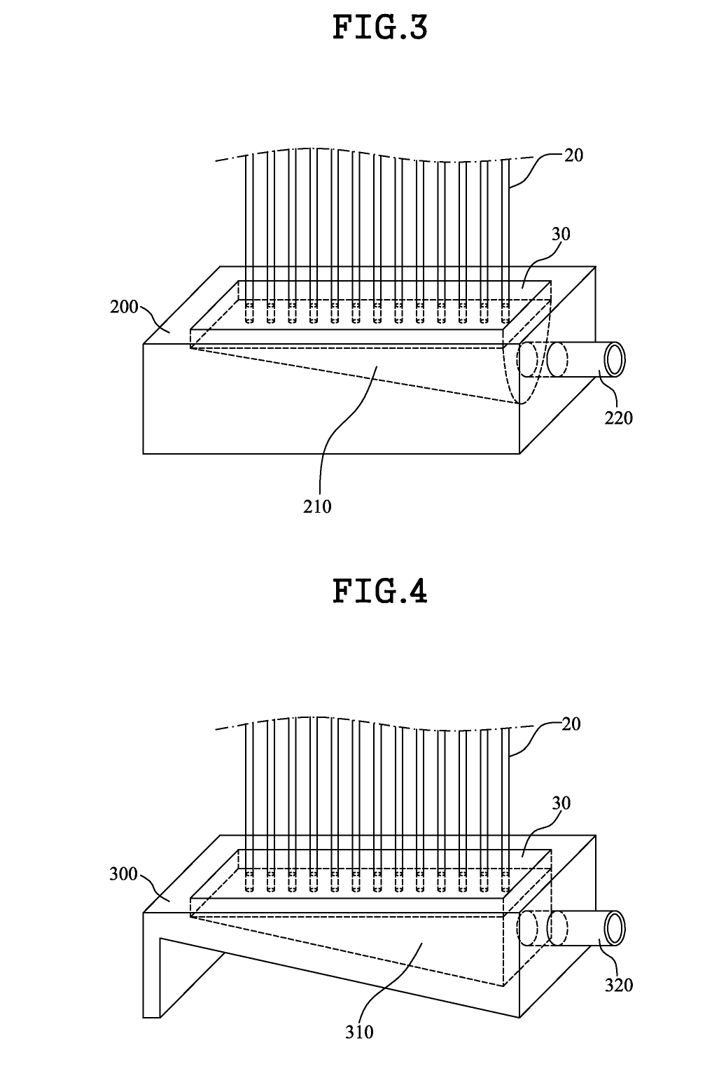

In case of one embodiment of the submerged hollow fiber membrane module shown in FIG. 2, the permeate collecting space 110 has the rectangular-shaped cross section to be perpendicular to the longitudinal direction of the header body 100. As shown in FIG. 3, a submerged hollow fiber membrane module according to another embodiment of the present invention may have a permeate collecting space 210 whose cross section has a semicircle to be perpendicular to a longitudinal direction of a header body 200. In this case, the cross section of the permeate collecting space 210 may include various shapes similar to the semicircle, for example, semi-elliptical shape, as well as the semicircle.

Furthermore, the cross section of the permeate collecting space is not limited to the aforementioned specific shape. It should be understood that all types, which are capable of gradually decreasing the cross-section size of the permeate collecting space 110 and 210 from one end of the header body 100 and 200 to the other end thereof to be in perpendicular to the longitudinal direction of the header body 100 and 200, are included within the scope of the present invention, regardless of the cross-section shape of the permeate collecting space 110 and 210.

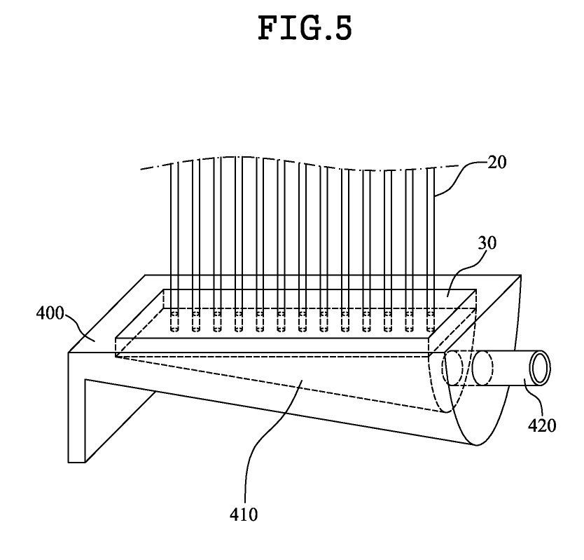

FIGS. 4 and 5 illustrate submerged hollow fiber membrane modules according to other embodiments of the present invention. As shown in FIGS. 4 and 5, not only one portion of a permeate collecting space 310 or 410 provided in a header body 300 or 400 but also one portion of the header body 300 or 400 is formed in such an inclined shape. That is, the cross-section size of the header body 300 or 400 is gradually decreased from its one end provided with a conduit 320 or 420 to its other end, wherein the cross section of the header body 300 or 400 is perpendicular to its longitudinal direction.

This structure of the header body 300 or 400 enables a minimization of material consumed for manufacturing the header body 300 or 400, thereby resulting in the improved product competitiveness and achieving the lightweight in filtering apparatus.

In case of the submerged hollow fiber membrane module described with reference to FIG. 4, the permeate collecting space 310 has the rectangular-shaped cross section, and the header body 300 also has the rectangular-shaped cross section corresponding to that of the permeate collecting space 310. Meanwhile, in case of the submerged hollow fiber membrane module described with reference to FIG. 5, the permeate collecting space 410 has the semicircle-shaped cross section, and the header body 400 also has the rounded cross section corresponding to that of the permeate collecting space 410, that is, the U-shaped cross section. In this case, it should be understood that the U-shaped cross section includes a wide range of shapes from the V-shaped cross section to the cross section having angular bottom corners.

Furthermore, the cross section of the header body is not limited to the aforementioned specific shape. It should be understood that all types, which are capable of gradually decreasing the cross-section size of the header body 300 and 400 from its one end provided with the conduit 320 and 420 to its other end, are included within the scope of the present invention, regardless of the cross-section shape of the header body 300 and 400.

The aforementioned embodiments of the submerged hollow fiber membrane modules can be applied to a vertical-type hollow fiber membrane module whose header is arranged in such a way that the longitudinal direction of the header is parallel to the surface of the liquid substrate (that is, the longitudinal direction of the hollow fiber membrane module is perpendicular to the surface of the liquid substrate) when the hollow fiber membrane module is submerged into the liquid substrate to be treated, as well as a horizontal-type hollow fiber membrane module whose header is arranged in such a way that the longitudinal direction of the header is perpendicular to the surface of the liquid substrate (that is, the longitudinal direction of the hollow fiber membrane is parallel to the surface of the liquid substrate) when the hollow fiber membrane module is submerged into the liquid substrate to be treated.

Accordingly, the header for filtering membrane according to the present invention and the filtering membrane module using the same has the following advantages.

First, the header for filtering membrane module according to the present invention and the filtering membrane module using the same are capable of achieving maximum usefulness for all hollow fiber membranes potted into the header without regard to its potting position, and maximizing efficiency in power consumption by securing the constant flow of permeate through the use of the relatively-low negative pressure.

Also, if the header body as well as the permeate collecting space has the inclined shape, the material consumed for manufacturing the header body can be minimized, thereby resulting in the improved product competitiveness and achieving the lightweight in filtering apparatus.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A header for filtering membrane module comprising:
a body with a permeate collecting space therein; and
a conduit at one end of the body, the conduit being in fluid communication with the permeate collecting space,
wherein at least a portion of the permeate collecting space has an inclined shape.

2. The header of claim 1, wherein a cross-section size of the permeate collecting space is gradually decreased from the one end of the body to the other end of the body, a cross section of the permeate collecting space being perpendicular to a longitudinal direction of the body.

3. The header of claim 2, wherein the cross section of the permeate collecting space has a semicircle shape.

4. The header of claim 1, wherein at least a portion of the body has an inclined shape.

5. The header of claim 4, wherein a cross-section size of the body is gradually decreased from the one end to the other end, a cross section of the body being perpendicular to a longitudinal direction of the body.

6. The header of claim 5, wherein the cross section of the body has a U-shape.

7. A filtering membrane module comprising:
a filtering membrane with an open end;
a header body with a permeate collecting space therein;
a potting layer for potting the filtering membrane into the header body in such a way that the open end of the filtering membrane is in fluid communication with the permeate collecting space; and
a conduit at one end of the header body, the conduit being in fluid communication with the permeate collecting space,
wherein at least a portion of the permeate collecting space has an inclined shape.

8. The filtering membrane module of claim 7, wherein a cross-section size of the permeate collecting space is gradually decreased from the one end of the header body to the other end of the header body, a cross section of the permeate collecting space being perpendicular to a longitudinal direction of the header body.

9. The filtering membrane module of claim 8, wherein the cross section of the permeate collecting space has a semicircle shape.

10. The filtering membrane module of claim 7, wherein at least a portion of the header body has an inclined shape.

11. The filtering membrane module of claim 10, wherein a cross-section size of the header body is gradually decreased from the one end to the other end, a cross section of the header body being perpendicular to a longitudinal direction of the header body.

12. The filtering membrane module of claim 11, wherein the cross section of the header body has a U-shape.
